(19) United States
(12) Patent Application Publication
(10) Pub. No.: US 2021/0188334 A1
(43) Pub. Date: Jun. 24, 2021

(54) DISTRIBUTION DEVICE, RECEIVING DEVICE, DATA DISTRIBUTION SYSTEM, AND DATA DISTRIBUTION METHOD

(71) Applicant: Mitsubishi Electric Corporation, Chiyoda-ku, Tokyo (JP)

(72) Inventor: Takeshi TAKEUCHI, Tokyo (JP)

(73) Assignee: Mitsubishi Electric Corporation, Chiyoda-ku, Tokyo (JP)

(21) Appl. No.: 16/756,195

(22) PCT Filed: Dec. 14, 2017
(86) PCT No.: PCT/JP2017/044944

§ 371 Date: Apr. 15, 2020

(51) Int. Cl. B61L 25/02; B61L 25/04; B61L 3/00

(52) U.S. Cl. CPC B61L 25/023; B61L 3/002; B61L 25/04

(57) ABSTRACT

A distribution device includes: a data acquisition unit acquiring operation data, which includes position information indicating train position when a measured value is acquired and information on the measured value, from a vehicle information management device collecting the measured value indicating operating state of equipment on a train; a history data management unit determining a representative value for each position information, generating and storing history data including the position information and information on the representative value, and distributing the history data to a data receiving device; and a connection management unit reading, based on the position information included in the operation data, the representative value corresponding to the position information from the history data, calculating a difference value between the measured value included in the operation data and the representative value, and distributing difference data including the position information and information on the difference value to the data receiving device.

### FIELD

The present invention relates to a distribution device for distributing data, a receiving device, a data distribution system, and a data distribution method.

### BACKGROUND

There has been a system that collects data continuously generated and analyzes the data in real time using the collected data. A distribution device that collects the data from a data source distributes necessary data to a receiving device that performs the data analysis. An increase in the number of receiving devices to which the data is distributed results in a delay in distributing the data from the distribution device due to factors caused by an increase in the amount of data to be distributed, the factors including an increase in the processing load and an increase in the bandwidth used by a network used for the data distribution.

Patent Literature 1 discloses a technique in which a stream data processing system that is a data distribution device transmits difference information between the latest data and previous data, and a client computer that is a data receiving device restores the latest data using the previous data and the difference information newly acquired. In Patent Literature 1, assuming that the latest data and the previous data have similar values, the amount of data to be distributed is reduced by transmitting the difference information instead of the data itself.

### CITATION LIST

### Patent Literature

Patent Literature 1: Japanese Patent Application

Laid-open No. 2009-134689

### SUMMARY

### Technical Problem

Also, in a train, a sensor measures a state of equipment mounted on the train, and a vehicle information management device collects the measured value measured by the sensor as continuously generated data for use in data analysis. However, when the technique of Patent Literature 1 is applied to a train, a difference between previous data and the latest data may be large depending on the travel route of the train. For example, on a curve, uphill, downhill, or the like, the brake air pressure or the like changes greatly with time, so that data of a measured item such as the brake air pressure more often has a large difference between the previous data and the latest data. Therefore, an increase in the amount of data to be distributed has resulted in a delay in distributing the data from the distribution device due to factors such as an increase in the processing load and an increase in the bandwidth used by a network.

The present invention has been made in view of the above, and an object of the present invention is to provide a distribution device that can reduce an amount of data when distributing data indicating a state of equipment mounted on a train.

### Solution to Problem

In order to solve the above problem and achieve the object, the distribution device according to an aspect of the present invention includes a data acquisition unit to acquire operation data from a vehicle information management device that collects a measured value indicating an operating state of equipment mounted on a train, the operation data including position information indicating a position of the train when the measured value is acquired and information on the measured value. The distribution device further includes a history data management unit to determine a representative value for each position information, generate history data including the position information and information on the representative value, store the history data, and distribute the history data to a receiving device. The distribution device further includes a connection management unit to read, on a basis of the position information included in the operation data, the representative value corresponding to the position information from the history data, calculate a difference value that is a difference between the measured value included in the operation data and the representative value, and distribute difference data including the position information and information on the difference value to the receiving device.

### Advantageous Effects of Invention

According to the present invention, the distribution device has an effect of being able to reduce the amount of data when distributing the data indicating the state of the equipment mounted on the train.

### BRIEF DESCRIPTION OF DRAWINGS

FIG. 1 is a diagram illustrating an example of the configuration of a data distribution system according to a first embodiment.

FIG. 2 is a block diagram illustrating an example of the configuration of a data distribution device according to the first embodiment.

FIG. 3 is a table illustrating an example of history data stored in a history data storage unit according to the first embodiment.

FIG. 4 is a block diagram illustrating an example of the configuration of a data receiving device according to the first embodiment.

FIG. 5 is a flowchart illustrating processing in which the data distribution device and the data receiving device synchronize the history data in the data distribution system according to the first embodiment.

FIG. 6 is a flowchart illustrating processing in which the data distribution device stores the history data in the data distribution system according to the first embodiment.

FIG. 7 is a flowchart illustrating processing in which the data distribution device distributes difference data in the data distribution system according to the first embodiment.

FIG. 8 is a diagram illustrating an example of a case where a processing circuit of the data distribution device according to the first embodiment includes a processor and a memory.

FIG. 9 is a diagram illustrating an example of a case where the processing circuit of the data distribution device according to the first embodiment includes dedicated hardware.

### DESCRIPTION OF EMBODIMENTS

A distribution device, a receiving device, a data distribution system, and a data distribution method according to embodiments of the present invention will now be described in detail with reference to the drawings. Note that the present invention is not limited to the embodiments.

### First Embodiment

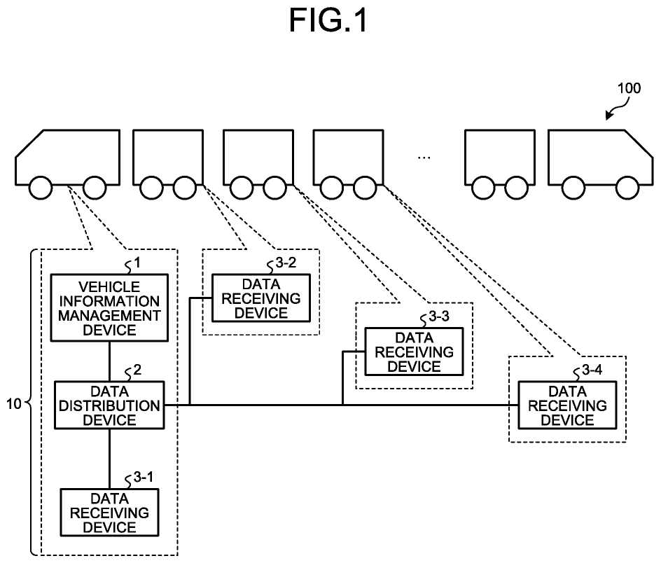

FIG. 1 is a diagram illustrating an example of the configuration of a data distribution system 10 according to a first embodiment of the present invention. The data distribution system 10 is a system mounted on a train 100. The data distribution system 10 includes a vehicle information management device 1, a data distribution device 2, and data receiving devices 3-1 to 3-4.

The vehicle information management device 1 collects, from on-board equipment (not shown) mounted on the train 100, a measured value indicating an operating state of the on-board equipment. The on-board equipment is, for example, equipment such as a motor for driving wheels, a brake, an air conditioner, a door, or the like. A plurality of pieces of the on-board equipment are mounted on the train 100. The measured value indicating the operating state of the on-board equipment is a value measured by a sensor (not shown) or the like, and is, for example, an air pressure value of the air used for an air brake when the on-board equipment is the air brake. The measured value indicating the operating state of the on-board equipment is stream data that is periodically collected by the vehicle information management device 1. Moreover, the vehicle information management device 1 periodically acquires position information of the train 100. The position information is indicated by kilometrage from a point serving as a starting point. The position information also includes information on the direction of travel on a line on which the train 100 operates. The information on the direction of travel is, for example, information such as an up line or a down line. The vehicle information management device 1 distributes, as operation data, the position information indicating the position of the train 100 when a measured value is acquired, information on a measured item corresponding to the measured value, and information on the measured value to the data distribution device 2. The vehicle information management device 1 periodically distributes the operation data to the data distribution device 2 during the operation of the train 100. Note that the vehicle information management device 1 may include, in the operation data, other information such as time information when the measured value is acquired.

The data distribution device 2 is a distribution device that acquires the operation data from the vehicle information management device 1 and distributes, on the basis of a distribution request acquired from the data receiving devices 3-1 to 3-4, information on a measured value of a measured item specified in the distribution request to the data receiving devices 3-1 to 3-4. The data distribution device 2 distributes, to the data receiving devices 3-1 to 3-4, difference data of the information on the measured value of the measured item specified in the distribution request among the operation data received from the vehicle information management device 1. The difference data has a small amount of data as compared to a case where the information on the measured value is distributed as is. Details of the difference data will be described later. The data distribution device 2 periodically distributes the difference data to the data receiving devices 3-1 to 3-4 during the operation of the train 100. The data distribution device 2 also distributes history data to the data receiving devices 3-1 to 3-4 after the start of the train 100 and before distributing the difference data. The history data is data required for the data receiving devices 3-1 to 3-4 to restore the measured value using the difference data. Note that the data distribution device 2 may distribute the history data to the data receiving devices 3-1 to 3-4 after the data distribution device 2 and the data receiving devices 3-1 to 3-4 are all started.

The data receiving devices 3-1 to 3-4 are receiving devices that make the distribution request to the data distribution device 2 and periodically acquire the difference data of the measured item specified in the distribution request during the operation of the train 100. The data receiving devices 3-1 to 3-4 restore the measured value collected by the vehicle information management device 1 using the history data acquired from the data distribution device 2 after the train 100 is started and the difference data periodically distributed. Note that the data receiving devices 3-1 to 3-4 are mounted on different vehicles of the train 100 in FIG. 1 as an example, but the data receiving devices 3-1 to 3-4 may be mounted on the same vehicle. Moreover, the data distribution device 2 and the data receiving devices 3-1 to 3-4 may be connected via a wired network or may be connected via a wireless network. In the case where the data distribution device 2 and the data receiving devices 3-1 to 3-4 are connected via a wireless network, the data receiving devices 3-1 to 3-4 may be located outside the train 100. The data receiving devices 3-1 to 3-4 will be referred to as a data receiving device 3 when not distinguished from one another.

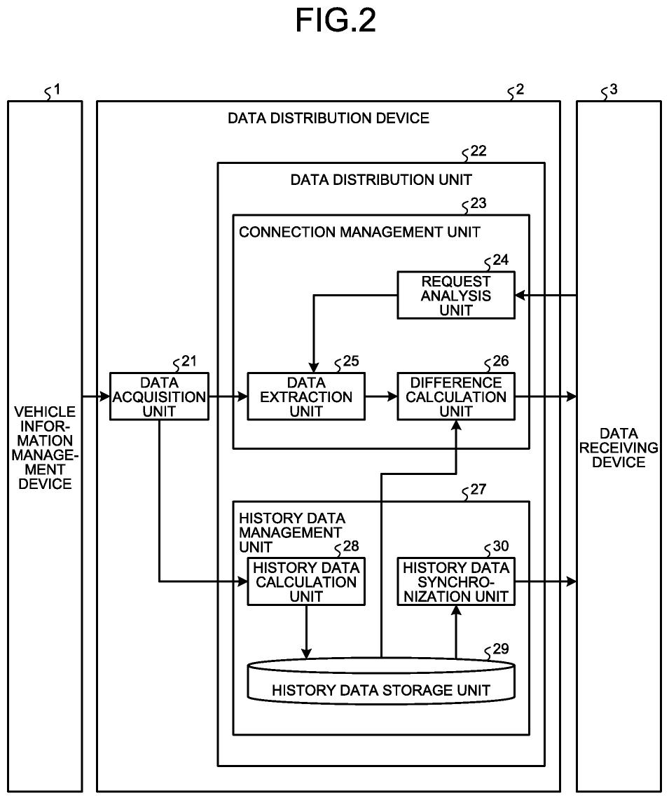

Next, the configuration of the data distribution device 2 will be described. FIG. 2 is a block diagram illustrating an example of the configuration of the data distribution device 2 according to the first embodiment. The data distribution device 2 includes a data acquisition unit 21 and a data distribution unit 22. The data distribution unit 22 includes a connection management unit 23 and a history data management unit 27.

The data acquisition unit 21 acquires the operation data from the vehicle information management device 1. The data acquisition unit 21 duplicates the operation data acquired and outputs the operation data to the connection management unit 23 and the history data management unit 27 of the data distribution unit 22.

On the basis of the distribution request acquired from the data receiving device 3, the data distribution unit 22 extracts the measured value of the measured item specified in the distribution request from the operation data acquired by the data acquisition unit 21. The data distribution unit 22 generates the difference data on the basis of the measured value of the measured item extracted, and distributes the difference data to the data receiving device 3. The data distribution unit 22 also distributes the history data to the data receiving device 3 after the start of the train 100 and before distributing the difference data.

In the data distribution unit 22, the history data management unit 27 includes a history data calculation unit 28, a history data storage unit 29, and a history data synchronization unit 30.

The history data calculation unit 28 uses the operation data acquired from the data acquisition unit 21 to determine, for each measured item, a representative value for each position information using measured values of the operation data acquired at different times. The measured values of the operation data acquired at different times include, for example, a measured value of the latest operation data and a measured value of the operation data acquired in the past. The history data calculation unit 28 for example calculates, for each measured item, an average value using the measured value of the latest operation data and the measured value of the operation data acquired in the past for each position information, and determines the average value calculated to be the representative value. The history data calculation unit 28 may determine a median value of a plurality of measured values to be the representative value. The following description relates to the case where the representative value is the average value. The history data calculation unit 28 causes the history data storage unit 29 to store the position information, information on the measured item, and information on the average value as the history data. The history data calculation unit 28 may store the operation data acquired in the past in a built-in storage unit or in the history data storage unit 29.

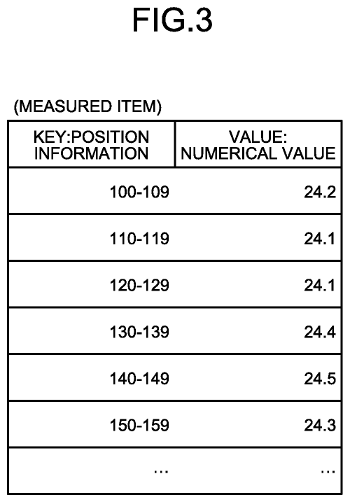

The history data storage unit 29 stores the history data including the information on the average value determined by the history data calculation unit 28. FIG. 3 is a table illustrating an example of the history data stored in the history data storage unit 29 according to the first embodiment. The history data illustrated in FIG. 3 indicates an average value calculated for each position information regarding a certain measured item. In FIG. 3, values represented by numerical values are the average values. When a difference calculation unit 26 described later searches the history data in the history data storage unit 29, the position information serves as a key and the numerical value, that is, the average value, serves as a value. In the example of FIG. 3, a value representing the position information is in meters, and the position information is in increments of one meter. Moreover, in the example of FIG. 3, in order to reduce the storage capacity of the history data storage unit 29, the history data calculation unit 28 treats ten meters of the position information as one unit, calculates the average value of the ten meters, and causes the history data storage unit 29 to store the average value. The history data storage unit 29 stores the history data similar to the table illustrated in FIG. 3 for each measured item. Note that the history data storage unit 29 may add a numerical value column on the right side of the numerical value in the table illustrated in FIG. 3, list values of average values calculated for a different measured item in the column, and store history data corresponding to a plurality of measured items in the form of one table. As for the position information, the history data calculation unit 28 may calculate the history data for each meter instead of putting together the plurality of pieces of position information as illustrated in FIG. 3, and cause the history data storage unit 29 to store the history data.

The history data synchronization unit 30 distributes the latest history data, which is stored in the history data storage unit 29 at the time of start of the train 100, to the data receiving device 3 after the start of the train 100 and before the difference calculation unit 26 described later distributes the difference data. As a result, the history data stored in the data distribution device 2 and the data receiving device 3 can be synchronized. That is, the data distribution device 2 and the data receiving device 3 hold the history data of the same contents.

In the data distribution unit 22, the connection management unit 23 includes a request analysis unit 24, a data extraction unit 25, and the difference calculation unit 26.

The request analysis unit 24 analyzes the distribution request, which is a request acquired from the data receiving device 3, and determines the measured item within the operation data to be distributed to the data receiving device 3, from which the distribution request is acquired, on the basis of the measured item specified in the distribution request.

On the basis of the specification of the measured item from the request analysis unit 24, the data extraction unit 25 extracts the operation data for the measured item specified from the operation data that is acquired from the data acquisition unit 21.

On the basis of the position information and information on the measured item included in the operation data extracted by the data extraction unit 25, the difference calculation unit 26 reads the average value corresponding to the same position information for each measured item from the history data stored in the history data storage unit 29. Specifically, the difference calculation unit 26 searches the history data storage unit 29 using the position information as a key, and reads the average value corresponding to the position information. For each measured item, the difference calculation unit 26 calculates a difference value that is a difference between the measured value included in the operation data extracted by the data extraction unit 25 and the average value included in the history data in the history data storage unit 29 for each position information. The difference calculation unit 26 distributes difference data to the data receiving device 3 from which the distribution request is acquired, the difference data including the position information and information on the measured item included in the operation data extracted by the data extraction unit 25, and information on the difference value calculated.

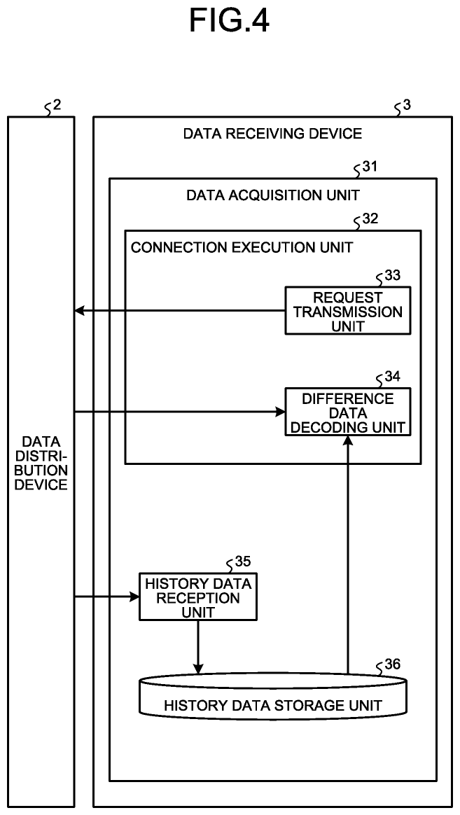

Next, the configuration of the data receiving device 3 will be described. FIG. 4 is a block diagram illustrating an example of the configuration of the data receiving device 3 according to the first embodiment. The data receiving device 3 includes a data acquisition unit 31. The data acquisition unit 31 acquires the history data from the data distribution device 2. The data acquisition unit 31 also makes the distribution request specifying a necessary measured item to the data distribution device 2, and acquires the difference data for the measured item specified in the distribution request. The data acquisition unit 31 uses the history data and difference data acquired to restore the measured value of the measured item specified in the distribution request. The data acquisition unit 31 includes a connection execution unit 32, a history data reception unit 35, and a history data storage unit 36.

The history data reception unit 35 receives the history data from the history data synchronization unit 30 of the data distribution device 2 after the start of the train 100. The history data reception unit 35 causes the history data storage unit 36 to store the history data received.

The history data storage unit 36 stores the history data received by the history data reception unit 35. The content of the history data stored in the history data storage unit 36 is identical to the content of the history data that is stored in the history data storage unit 29 of the data distribution device 2 and is used when the difference calculation unit 26 of the data distribution device 2 calculates the difference value.

The connection execution unit 32 makes the distribution request specifying the necessary measured item to the data distribution device 2, and acquires the difference data based on the measured item specified in the distribution request. The connection execution unit 32 includes a request transmission unit 33 and a difference data decoding unit 34.

The request transmission unit 33 makes the distribution request specifying the necessary measured item to the data distribution device 2. The request transmission unit 33 accepts an operation by a user specifying the measured item from an input unit (not shown), generates the distribution request specifying the measured item accepted, and transmits the distribution request to the data distribution device 2.

The difference data decoding unit 34 acquires, from the data distribution device 2, the difference data for the measured item specified in the distribution request by the request transmission unit 33. On the basis of the position information and information on the measured item included in the difference data acquired, the difference data decoding unit 34 reads the average value corresponding to each position information for each measured item from the history data in the history data storage unit 36. For each measured item, the difference data decoding unit 34 adds together the difference value included in the difference data acquired and the average value read for each position information, and restores the measured value of the measured item specified in the distribution request by the request transmission unit 33.

In the present embodiment, the data distribution device 2 does not distribute information on the measured value as is to the data receiving device 3, but distributes information on the difference value between the average value of the measured values measured at the same train position in past travel and the latest measured value. The train 100 travels on a route predetermined by a line. The route on which the train 100 travels typically includes a curve, an uphill, a downhill, and the like. For example, when the train 100 comes to a curve and applies the brakes, the air pressure of the brakes changes from the air pressure before coming to the curve. Thus, in time sequence, the air pressure of the brakes varies in the amount of change, that is, a difference between two pieces of data that are continuous in time series.

On the other hand, when the train 100 comes to a curve, the air pressure of the brakes at the train position where the train 100 comes to the curve is estimated to take a value similar to the air pressure of the brakes at the same train position when the train 100 traveled the same line in the past. In other words, the difference value between the average value of the measured values measured at the same train position and the latest measured value is estimated to be smaller than the difference value between the previous measured value and the latest measured value that are measured in time series. Also, the difference value between the average value of the measured values measured at the same train position and the latest measured value is estimated to fall within a certain range at each train position and not take a prominent value at a certain train position.

Therefore, the data distribution device 2 distributes, to the data receiving device 3, the information on the difference value between the average value of the measured values measured at the same train position and the latest measured value. The data distribution device 2 can reduce the bandwidth for distributing the information on the difference value, that is, reduce the amount of data, as compared to the case of distributing the measured values as is and the case of distributing the difference value between the two measured values measured in time series. The data distribution device 2 can reduce the amount of data and distribute the information on the difference value without generating an unnecessary bandwidth.

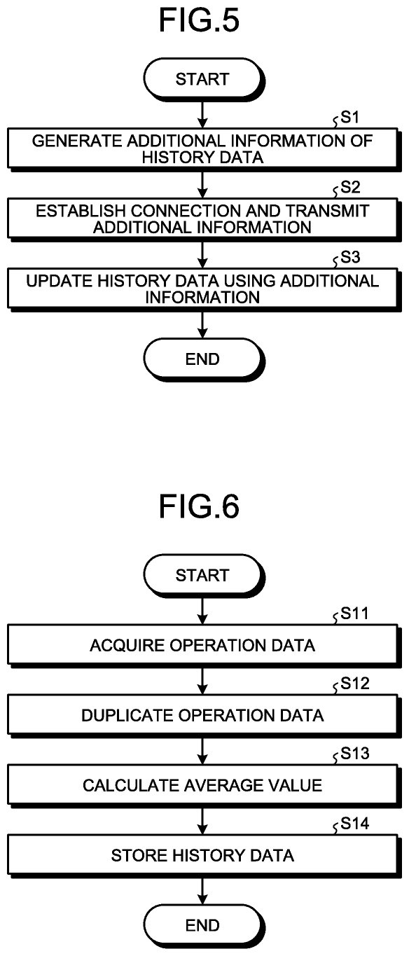

Next, data distribution processing in the data distribution system 10 will be described. First, the processing of synchronizing the history data between the data distribution device 2 and the data receiving device 3 will be described. FIG. 5 is a flowchart illustrating the processing in which the data distribution device 2 and the data receiving device 3 synchronize the history data in the data distribution system 10 according to the first embodiment.

In the data distribution device 2, after the start of the train 100, the history data synchronization unit 30 refers to the history data storage unit 29, obtains a difference between the history data at the time of the start of the train 100 last time and the latest history data acquired by the last operation, and generates information on the difference obtained as additional information (step S1). The history data synchronization unit 30 performs connection processing with the history data reception unit 35 of the data receiving device 3 to establish a connection therewith, and transmits the additional information to the history data reception unit 35 (step S2). Here, in the data distribution device 2, the difference calculation unit 26 calculates the difference value using the latest history data. That is, the difference calculation unit 26 updates the history data used for calculating the difference value from the history data at the time of the start of the train 100 last time to the latest history data. Note that when the train 100 is started next time, the latest history data used this time becomes the history data at the time of the start of the train 100 last time.

In the data receiving device 3, after the start of the train 100, the history data reception unit 35 performs the connection processing with the history data synchronization unit 30 of the data distribution device 2 to establish the connection therewith, and receives the additional information from the history data synchronization unit 30. The history data reception unit 35 updates the history data stored in the history data storage unit 36 using the additional information received (step S3). As a result, the data distribution device 2 and the data receiving device 3 can synchronize the history data and hold the history data having the same content.

Note that in the data distribution device 2, the history data synchronization unit 30 may read the history data stored in the history data storage unit 29 and transmit the history data to the data receiving device 3, and in the data receiving device 3, the history data reception unit 35 may overwrite, that is, update the history data stored in the history data storage unit 36 with the history data received. In the case of transmitting the history data as is, the history data synchronization unit 30 transmits a large amount of data to the history data reception unit 35 of the data receiving device 3 compared to the case of transmitting the additional information, but can reduce the processing load for generating the addition information. The history data synchronization unit 30 may transmit the additional information or the history data as is to the data receiving device 3 depending on the number of data receiving devices 3 to which the data is distributed.

Next, there will be described the processing in which the data distribution device 2 acquires the operation data from the vehicle information management device 1 after the train 100 starts operating, and stores the history data. FIG. 6 is a flowchart illustrating the processing in which the data distribution device 2 stores the history data in the data distribution system 10 according to the first embodiment.

In the data distribution device 2, the data acquisition unit 21 periodically acquires the operation data from the vehicle information management device 1 (step S11), and duplicates the operation data each time it is acquired (step S12). The data acquisition unit 21 outputs the duplicated operation data to the data extraction unit 25 and the history data calculation unit 28. The history data calculation unit 28 calculates, for each measured item, the average value of the measured values for each position information every time the operation data is acquired from the data acquisition unit 21 (step S13). As described above, the history data calculation unit 28 calculates the average value using the measured value of the latest operation data and the measured value of the operation data acquired in the past. Using the average value calculated, the history data calculation unit 28 causes the history data storage unit 29 to store information on the average value corresponding to each position information for each measured item as the history data (step S14). The data distribution device 2 repeatedly performs the above processing while periodically acquiring the operation data from the vehicle information management device 1.

Note that the history data calculation unit 28 does not update the history data used when the difference calculation unit 26 calculates the difference value, but causes the history data storage unit 29 to store the history data as another history data. At the end of the operation of the train 100, two pieces of the history data are stored in the history data storage unit 29. As described above, after the start of the train 100, the history data synchronization unit 30 generates the additional information from the difference between the history data at the time of the start of the train 100 last time and the latest history data. The two pieces of the history data stored in the history data storage unit 29 at the end of the operation of the train 100 serve as the history data at the time of the start of the train 100 last time and the latest history data when the train 100 is started next time.

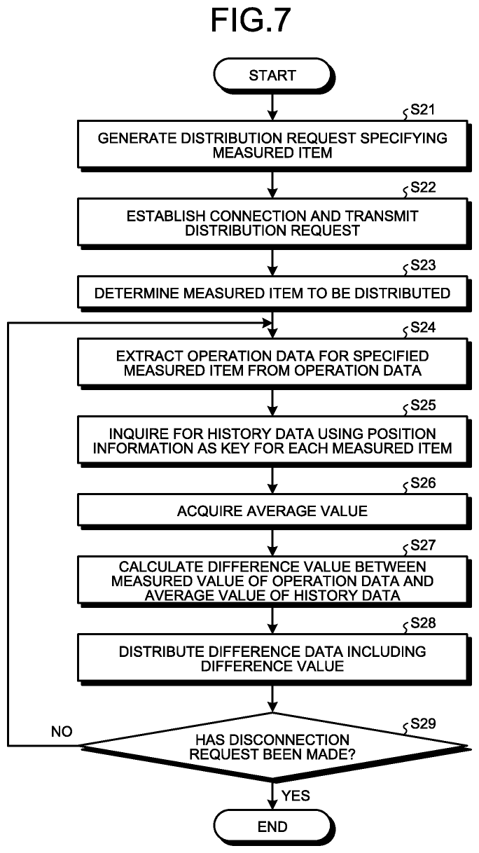

Next, there will be described the processing in which the data distribution device 2 acquires the operation data from the vehicle information management device 1 after the train 100 starts operating, calculates the difference value, and distributes the difference data to the data receiving device 3. FIG. 7 is a flowchart illustrating the processing in which the data distribution device 2 distributes the difference data in the data distribution system 10 according to the first embodiment.

In the data receiving device 3, the request transmission unit 33 receives specification of a measured item from a user, and generates a distribution request specifying the measured item desired (step S21). The request transmission unit 33 establishes a connection with the request analysis unit 24 of the data distribution device 2, and transmits the distribution request to the request analysis unit 24 (step S22).

In the data distribution device 2, the request analysis unit 24 establishes the connection upon receiving a connection request from the request transmission unit 33 of the data receiving device 3, and acquires the distribution request from the request transmission unit 33. The request analysis unit 24 analyzes the distribution request acquired and determines a measured item in the operation data to be distributed to the data receiving device 3 from which the distribution request is transmitted (step S23). On the basis of the specification of the measured item from the request analysis unit 24, the data extraction unit 25 extracts the operation data for the measured item specified from the operation data that is acquired from the data acquisition unit 21 (step S24).

The difference calculation unit 26 acquires the position information and information on the measured item from the operation data extracted by the data extraction unit 25. The difference calculation unit 26 uses the position information as a key and inquires of the history data storage unit 29 about the history data for each measured item, that is, the measured item specified by the data receiving device 3 (step S25). The difference calculation unit 26 acquires, from the history data storage unit 29, the average value corresponding to the position information acquired for each measured item extracted by the data extraction unit 25 (step S26). Note that the difference calculation unit 26 may acquire the operation data from the data acquisition unit 21, acquire the information on the measured item specified by the distribution target from the request analysis unit 24, and perform the processings in steps S25 and S26 in parallel with the processing by the data extraction unit 25 in step S24.

The difference calculation unit 26 calculates the difference value between the measured value of the operation data extracted by the data extraction unit 25 and the average value of the history data (step S27). The difference calculation unit 26 distributes, to the data receiving device 3 from which the distribution request is transmitted, the difference data including the position information and information on the measured item that are included in the operation data extracted by the data extraction unit 25 and the difference value calculated (step S28). If no disconnection request has been made from the data receiving device 3 (No in step S29), the data distribution device 2 repeatedly performs the processings from step S24 to step S28. If a disconnection request has been made from the data receiving device 3 (Yes in step S29), the data distribution device 2 breaks the connection and ends the processing. When a plurality of the data receiving devices 3 are connected to the data distribution device 2, the data distribution device 2 and the data receiving devices 3 perform the above processing for each combination of the data distribution device 2 and the data receiving device 3.

Next, a hardware configuration of the data distribution device 2 will be described. In the data distribution device 2, the history data storage unit 29 is a memory. The other configurations in the data distribution device 2 are implemented by a processing circuit. That is, the data distribution device 2 includes the processing circuit that can reduce the amount of data of the measured value included in the operation data and distribute the data to the data receiving device 3 by using the position information of the train 100. The processing circuit may be a memory and a processor executing programs stored in the memory, or may be dedicated hardware.

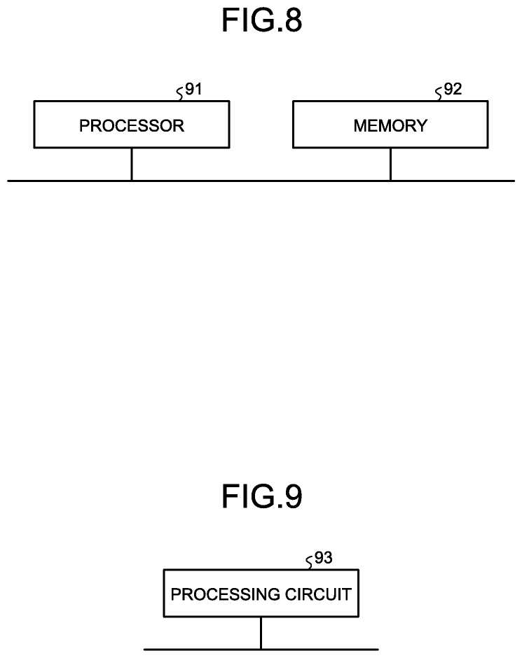

FIG. 8 is a diagram illustrating an example of a case where the processing circuit of the data distribution device 2 according to the first embodiment includes a processor and a memory. When the processing circuit incudes a processor 91 and a memory 92, each function of the processing circuit of the data distribution device 2 is implemented by software, firmware, or a combination of software and firmware. The software or firmware is described as programs and stored in the memory 92. The processing circuit implements the functions by the processor 91 reading and executing the programs stored in the memory 92. That is, the processing circuit includes the memory 92 for storing the programs, the execution of which results in reducing the amount of data of the measured values included in the operation data and distributing the data to the data receiving device 3 by using the position information of the train 100. It can also be said that these programs cause a computer to execute procedures and methods related to the data distribution device 2.

Here, the processor 91 may be a central processing unit (CPU), a processing unit, an arithmetic unit, a microprocessor, a microcomputer, or a digital signal processor (DSP). The memory 92 corresponds to a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like.

FIG. 9 is a diagram illustrating an example of a case where the processing circuit of the data distribution device 2 according to the first embodiment includes dedicated hardware. When the processing circuit includes dedicated hardware, a processing circuit 93 illustrated in FIG. 9 corresponds to a single circuit, a complex circuit, a programmed processor, a parallel-programmed processor, an application specific integrated circuit (ASIC), a field programmable gate array (FPGA), or a combination of those, for example. The functions of the data distribution device 2 may be implemented individually or collectively by the processing circuit 93.

Note that the functions of the data distribution device 2 may be implemented partly by dedicated hardware and partly by software or firmware. The processing circuit can thus implement the aforementioned functions by dedicated hardware, software, firmware, or a combination of these.

A hardware configuration of the data receiving device 3 is similar to the hardware configuration of the data distribution device 2. In the data receiving device 3, the history data storage unit 36 is a memory. The other configurations in the data receiving device 3 are implemented by a processing circuit.

As described above, according to the present embodiment, the data distribution device 2 distributes, to the data receiving device 3, the information on the difference value between the average value of the measured values measured at the same train position in past travel and the latest measured value. The data distribution device 2 can thus reduce the amount of data and distribute the information on the difference value without generating an unnecessary bandwidth and without being affected by the route on which the train 100 travels.

Note that the history data stored in the history data storage unit 29 of the train 100 can be used for another train running on the same line. For example, when another train is to be operated on a line different from the previous one, the other train can easily acquire an average value based on past measured values by using the history data of the train 100.

### Second Embodiment

In a second embodiment, the data distribution device 2 and the data receiving device 3 include a plurality of pieces of history data for each measured item. Differences from the first embodiment will be described.

The configurations of the data distribution system 10, the data distribution device 2, and the data receiving device 3 are similar to those of the first embodiment. In the train 100, the measured value of each measured item is considered to be a measured value similar to the measured value that is measured in the past at the same train position. However, it is assumed that the characteristics of the measured value vary depending on conditions such as the operating mode of the train 100, the operation hours of the train 100, and the weather at the time of operation of the train 100.

For example, even at the same train position, the speed of the train 100 is different in a case where the train 100 is operated as a type of train that stops at each station and in a case where the train is operated as a type of train that does not stop at all stations such as an express or rapid train, so that the measured value may exhibit different characteristics depending on the measured item.

Also, even when the train 100 is operated as the same type of train, the speed of the train 100, the level of congestion of passengers, and the like are different even at the same train position in the morning and evening commuting hours and in the daytime hours, so that the measured value may exhibit different characteristics depending on the measured item. Similarly, even at the same train position, the speed of the train 100, the level of congestion of passengers, and the like are different in a case where the train 100 is operated on weekdays and in a case where the train is operated on holidays, so that the measured value may exhibit different characteristics depending on the measured item.

In addition, different weather conditions on the day on which the train 100 is operated such as rainy, sunny, and cloudy weather cause differences in the effectiveness of the brakes, the level of congestion of passengers, and the like, so that the measured value may exhibit different characteristics depending on the measured item. Similarly, even at the same train position, the set temperature of an air conditioner and the like are different in a case where the temperature of the day on which the train 100 is operated is high and in a case where the temperature is low, so that the measured value may exhibit different characteristics depending on the measured item.

Therefore, in the second embodiment, the vehicle information management device 1 distributes, to the data distribution device 2, the operation data while including information such as train type information, time information, and weather information. In the data distribution device 2, the history data calculation unit 28 calculates the history data using the operation data under the same condition, and causes the history data storage unit 29 to store the history data. Specifically, when the operation data includes the train type information such as local and express trains, the history data calculation unit 28 calculates the history data for each train type. For example, the history data calculation unit 28 calculates history data for the local train and history data for the express train, and causes the history data storage unit 29 to store the history data. When the operation data includes the time information, the history data calculation unit 28 calculates the history data for each time period. For example, the history data calculation unit 28 calculates history data for the time period of 7:00 to 8:59 and history data for the time period of 9:00 to 10:59, and causes the history data storage unit 29 to store the history data. When the operation data includes the weather information, the history data calculation unit 28 calculates the history data for each weather. For example, the history data calculation unit 28 calculates history data for the sunny weather and history data for the rainy weather, and causes the history data storage unit 29 to store the history data. Note that the history data calculation unit 28 may calculate the history data using the information on a plurality of conditions. For example, the history data calculation unit 28 may calculate the history data for the local train, for the time period of 7:00 to 8:59, and for the sunny weather, and causes the history data storage unit 29 to store the history data. The history data calculation unit 28 classifies the operation data into a plurality of types using at least one of the train type, time period, and weather information, generates the history data for each type, and causes the history data storage unit 29 to store the history data for each type.

The history data storage unit 29 stores all the history data calculated by the history data calculation unit 28. The storage capacity of the history data storage unit 29 of the second embodiment is larger than the storage capacity of the history data storage unit 29 of the first embodiment.

The history data synchronization unit 30 generates additional information for all the history data stored in the history data storage unit 29, and transmits the additional information to the history data reception unit 35 of the data receiving device 3. Note that the history data synchronization unit 30 may immediately acquire the operation data from the train 100 after the train 100 is started, select one piece of history data from a plurality of pieces of the history data on the basis of the conditions of the current train operation, generate the additional information only for the history data selected, and transmit the additional information to the history data reception unit 35 of the data receiving device 3. Alternatively, the history data synchronization unit 30 may immediately acquire the operation data from the train 100 after the train 100 is started, select one piece of history data from a plurality of pieces of the history data on the basis of the conditions of the current train operation, and transmit the selected history data as is to the history data reception unit 35 of the data receiving device 3.

The difference calculation unit 26 selects one piece of history data from the plurality of pieces of the history data stored in the history data storage unit 29 on the basis of the conditions of the current train operation, and calculates a difference value using a representative value of the selected history data. The difference calculation unit 26 may acquire information on the history data to be used from the history data synchronization unit 30.

In the data receiving device 3, the history data reception unit 35 receives the history data corresponding to the current operation of the train 100 from the data distribution device 2, and then causes the history data storage unit 36 to store the history data. The difference data decoding unit 34 restores the measured value using the history data distributed from the data distribution device 2 and stored in the history data storage unit 36. Note that the processing in which the data receiving device 3 transmits the distribution request to the data distribution device 2, and the data distribution device 2 generates the difference data on the basis of the distribution request and distributes the difference data to the data receiving device 3 is similar to that of the first embodiment.

As described above, according to the present embodiment, the data distribution device 2 stores the plurality of pieces of the history data for each condition on the basis of the conditions of the train 100 at the time of operation, generates the difference data using the history data that matches the conditions at the time of operation, and distributes the difference data to the data receiving device 3. The magnitude of the difference value at each train position can be expected to be smaller than that of the first embodiment. Therefore, the data distribution device 2 can further reduce the amount of data when distributing the difference data as compared to the case of the first embodiment.

### Third Embodiment

In a third embodiment, the data distribution device 2 generates difference data for all measured items included in the operation data acquired, and transmits the difference data to the data receiving device 3. Differences from the first embodiment will be described.

As described above, the data receiving device 3 can be connected to the data distribution device 2 via a wireless network. In this case, the data receiving device 3 can be installed in a ground facility and used as a device for collecting information on the operating state of the train 100 on the ground side. For example, in the data receiving device 3, the request transmission unit 33 specifies, in the distribution request to the data distribution device 2, all the measured items included in the operation data generated by the vehicle information management device 1. The data distribution device 2 generates the difference data for all the measured items and distributes the data to the data receiving device 3. As a result, the data receiving device 3 can acquire all the information included in the operation data generated by the vehicle information management device 1 via the data distribution device 2.

Moreover, when the data distribution device 2 has not received the distribution request from the data receiving device 3 within a specified time after establishing a connection with the data receiving device 3, the data distribution device 2 may determine that the distribution request for all the measured items has been made from the data receiving device 3. The data distribution device 2 generates the difference data for all the measured items and distributes the data to the data receiving device 3. As a result, the data receiving device 3 can acquire all the information included in the operation data generated by the vehicle information management device 1 via the data distribution device 2 without transmitting the distribution request. Here, all the measured items need only include necessary measured items that are specified in advance between the data receiving device 3 and the data distribution device 2 when the distribution request is not transmitted.

When only the data receiving device 3 on the ground side is connected to the data distribution device 2, the data distribution device 2 may generate the difference data for all the measured items after establishing a connection with the data receiving device 3 and distribute the data to the data receiving device 3. As a result, the data receiving device 3 can acquire all the information included in the operation data generated by the vehicle information management device 1 via the data distribution device 2 without transmitting the distribution request. Here, all the measured items need only include necessary measured items that are specified in advance between the data receiving device 3 and the data distribution device 2 when the distribution request is not transmitted.

As described above, according to the present embodiment, the data distribution device 2 generates the difference data for all the measured items and distributes the data to the data receiving device 3 when the distribution request specifying all the measured items is acquired from the data receiving device 3, or when the specified condition is met. As a result, the data receiving device 3 can acquire all the information included in the operation data generated by the vehicle information management device 1.

The configurations illustrated in the aforementioned embodiment merely illustrate examples of the content of the present invention, and can thus be combined with another known technique or partially omitted and/or modified without departing from the scope of the present invention.

### REFERENCE SIGNS LIST

1 vehicle information management device; 2 data distribution device; 3, 3-1 to 3-4 data receiving device; 10 data distribution system; 21, 31 data acquisition unit; 22 data distribution unit; 23 connection management unit; 24 request analysis unit; 25 data extraction unit; difference calculation unit; 27 history data management unit; 28 history data calculation unit; 29, 36 history data storage unit; 30 history data synchronization unit; 32 connection execution unit; 33 request transmission unit; 34 difference data decoding unit; 35 history data reception unit; 100 train.

1. A distribution device comprising:
a data acquirer to acquire operation data from a vehicle information management device that collects a measured value indicating an operating state of equipment mounted on a train, the operation data including position information indicating a position of the train when the measured value is acquired and information on the measured value;
a history data manager to determine a representative value for each position information, generate history data including the position information and information on the representative value, store the history data, and distribute the history data to a receiving device; and
a connection manager to read, on a basis of the position information included in the operation data, the representative value corresponding to the position information from the history data, calculate a difference value that is a difference between the measured value included in the operation data and the representative value, and distribute difference data including the position information and information on the difference value to the receiving device.

2. The distribution device according to claim 1, wherein
the operation data further includes information on a measured item,
the history data manager determines the representative value for each measured item and generates the history data including the position information, the measured item, and the representative value, and
when the connection manager acquires a distribution request specifying a measured item from the receiving device, the connection manager calculates a difference value for the measured item specified, and distributes difference data of the measured item specified to the receiving device from which the distribution request is acquired.

3. The distribution device according to claim 2, wherein
when a plurality of the receiving devices are present and each make a distribution request specifying a different measured item, the connection manager calculates a difference value for the measured item specified for each of the receiving devices and distributes difference data of the measured item specified to a corresponding one of the receiving devices from which the distribution request is made.

4. The distribution device according to claim 1, wherein
the history data manager classifies the operation data into a plurality of types using at least one condition among a train type, a time period, and weather, generates and stores the history data for each of the types, selects one history data from a plurality of the history data on a basis of a condition of a current train operation, and distributes the history data selected to the receiving device, and
the connection manager calculates the difference value using the representative value of the history data selected.

5. The distribution device according to claim 1, wherein
the representative value is an average value of the measured values included in the operation data acquired at different times.

6. A receiving device comprising:
a history data storage to store history data acquired from the distribution device according to claim 1; and
a connection executer to acquire difference data from the distribution device and restore, for each position information, a measured value indicating an operating state of equipment mounted on a train by using a difference value included in the difference data and a representative value included in the history data.

7. The receiving device according to claim 6, wherein
the connection executer makes a distribution request specifying a measured item to the distribution device, acquires difference data for the measured item specified, and restores the measured value of the measured item specified.

8. A data distribution system comprising:
a distribution device including:
a data acquirer to acquire operation data from a vehicle information management device that collects a measured value indicating an operating state of equipment mounted on a train, the operation data including position information indicating a position of the train when the measured value is acquired and information on the measured value;
a history data manager to determine a representative value for each position information, generate history data including the position information and information on the representative value, store the history data, and distribute the history data to a receiving device; and
a connection manager to read, on a basis of the position information included in the operation data, the representative value corresponding to the position information from the history data, calculate a difference value that is a difference between the measured value included in the operation data and the representative value, and distribute difference data including the position information and information on the difference value to the receiving device; and
the receiving device according to claim 6.

9. The data distribution system according to claim 8, wherein
the receiving device makes a distribution request specifying a measured item to the distribution device, acquires difference data for the measured item specified, and restores a measured value of the measured item specified, and
the distribution device calculates a difference value for the measured item specified in the distribution request, and distributes the difference data of the measured item specified to the receiving device from which the distribution request is made.

10. The data distribution system according to claim 9, wherein
when the distribution device acquires a distribution request specifying a different measured item from each of a plurality of the receiving devices present, the distribution device calculates a difference value for the measured item specified for each of the receiving devices and distributes difference data of the measured item specified to a corresponding one of the receiving devices from which the distribution request is acquired.

11. The data distribution system according to claim 8, wherein
the distribution device classifies the operation data into a plurality of types using at least one piece of information among a train type, a time period, and weather, generates and stores the history data for each of the types, selects one history data from a plurality of the history data on a basis of a condition of a current train operation, distributes the history data selected to the receiving device, and calculates the difference value using the representative value of the history data selected, and
the receiving device restores the measured value indicating the operating state of the equipment mounted on the train by using the history data distributed.

12. The data distribution system according to claim 8, wherein
the representative value is an average value of the measured values included in the operation data acquired at different times.

13. A data distribution method comprising:
a data acquisition of a distribution device acquiring operation data from a vehicle information management device that collects a measured value indicating an operating state of equipment mounted on a train, the operation data including position information indicating a position of the train when the measured value is acquired and information on the measured value;
a history data distribution of the distribution device determining a representative value for each position information using the operation data, generating history data including the position information and information on the representative value, storing the history data, and distributing the history data to a receiving device;
a difference data distribution of the distribution device reading, on a basis of the position information included in the operation data, the representative value corresponding to the position information from the history data, calculating a difference value that is a difference between the measured value included in the operation data and the representative value, and distributing difference data including the position information and information on the difference value to the receiving device; and
a restoring step of the receiving device acquiring the history data and the difference data from the distribution device and restoring, for each position information, the measured value using the difference value included in the difference data and the representative value included in the history data.

14. The data distribution method according to claim 13, further comprising
a requesting of the receiving device making a distribution request specifying a measured item to the distribution device, wherein
in the history data distribution, the distribution device determines the representative value for each measured item and generates the history data including the position information, the measured item, and the representative value,
in the difference data distribution, the distribution device calculates a difference value for the measured item specified in the distribution request, and distributes difference data of the measured item specified to the receiving device from which the distribution request is made, and
in the restoring, the receiving device acquires the difference data for the measured item specified, and restores the measured value of the measured item specified.

15. The data distribution method according to claim 14, wherein
in the difference data distribution, when the distribution device acquires the distribution request specifying a different measured item from each of a plurality of the receiving devices present, the distribution device calculates a difference value for the measured item specified for each of the receiving devices and distributes difference data of the measured item specified to a corresponding one of the receiving devices from which the distribution request is acquired.

16. The data distribution method according to claim 13, wherein
in the history data distribution, the distribution device classifies the operation data into a plurality of types using at least one piece of information among a train type, a time period, and weather, generates and stores the history data for each of the types, selects one history data from a plurality of the history data on a basis of a condition of a current train operation, and distributes the history data selected to the receiving device,
in the difference data distribution, the distribution device calculates the difference value using the representative value of the history data selected, and
in the restoring, the receiving device restores the measured value using the history data distributed.

17. The data distribution method according to claim 13, wherein
the representative value is an average value of the measured values included in the operation data acquired at different times.
